(19) United States
(12) Patent Application Publication
(10) Pub. No.: US 2008/0257249 A1
(43) Pub. Date: Oct. 23, 2008

(54) "U" shaped, clear plastic support bar attachment to enhance the display of in ground pole mounted flags and/or banners three feet in vertical width of larger

(76) Inventor: Charles Walter Brong, Boyertown, PA (US)

Correspondence Address: Charles Walter Brong Sr., 15 Sunrise Drive, Boyertown, PA, 19512-2023, US

(21) Appl. No.: 11/785,773

(22) Filed: Apr. 20, 2007

(51) Int. Cl. G09F 17/00

(52) U.S. Cl. 116/174

(57) ABSTRACT

The support bar has a two-fold purpose. The goal in raising and displaying a national flag is to do so in a manner designed to catch the eye. This is better accomplished by spreading it out and making it noticeably more appealing. Use of the support bar invention guarantees a full extension of the width of the flag between the attachment points. In the case of displaying banners the goal is to make the message clearly apparent to sight and understanding. The support bar lends itself to accomplish both goals more effectively by helping to maintain full exposure of the face of the banner.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING A TABLE OR A COMPUTER PROGRAM LISTING COMPACT DISC APPENDIX

Not Applicable

### BACKGROUND OF INVENTION

Invention pertains to displaying pole mounted flags and/or banners that are raised and lowered by the combined use of an attached pole pulley and draw ropes.

It can also be used on poles attached to a building wall where the item displayed is not attached to the pole permanently.

The support bar is installed over the edge of the attachment side of flag or banner. It is held in place when swivel hooks tied to the draw ropes are fastened in the overlapping holes and eyelets located at the ends of support bar and item displayed, insuring a constant vertical width. (See drawing FIG. 2A)

Pole mounted flags or banners presently displayed rely exclusively on rope tension for support in order to keep the face of item displayed completely exposed and unfurled.

### BRIEF SUMMARY OF INVENTION

Installation of invention provides a rigidity that holds item displayed in a vertical position parallel to the pole at the points of attachment; resulting in a more uniform display of flag or banner. Without this additional support, inclement weather conditions tend to reduce tension on the draw ropes at the fastening points. This causes the item displayed to bulge outward and become furled more easily. (See FIG. 3A)

### BRIEF DESCRIPTION OF SEVERAL VIEWS OF THE DRAWINGS

FIG. 1A: Dimensions of support bar designed for flags or banners six feet wide or less.

1. Thickness 1/16 of an inch
2. Depth 1¼ inch
3. Width ¼ inch
Thickness of support bars six feet or greater would vary in order to provide proper rigidity.

FIG. 2A: View of support bar installed over attachment width of flag or banner.

1. Pole pulley
2. One-half inch diameter attachment holes on support bar ends

### 3. Support bar

4. Draw ropes
Diameter of attachment holes on support bar greater than six feet in length are governed by width of item displayed.

FIG. 3A: View of bulging out effect without vertical support bar.

1. Draw ropes
2. Draw rope attachments
3. Bulging out caused by improper tension on draw ropes

### DETAILED DESCRIPTION OF THE INVENTION

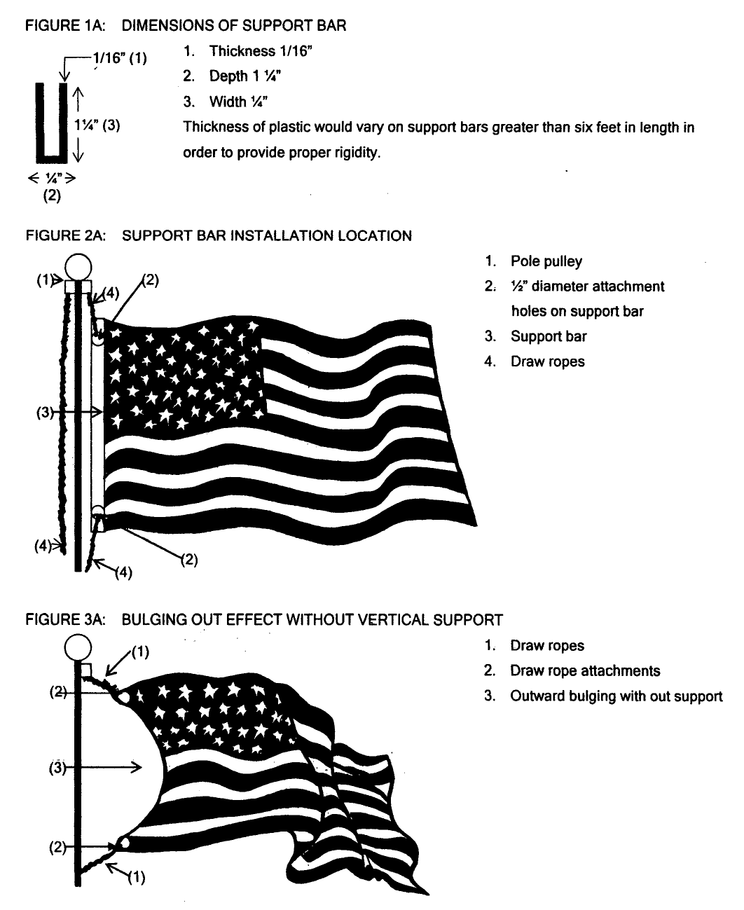

Invention consists of a “U” shaped inflexible piece of clear plastic material one-sixteenth inch in thickness, one and a quarter inch in depth and one quarter inch in width (see FIG. 1A). A round hole one-half inch in diameter is located at each end of support bar to match eyelets on displayed item. Foregoing dimensions apply to support bars used on flags or banners that are between three feet and six feet in vertical width. Support bars in excess of six feet may require increased dimensional sizes to insure ultimate performance.

Use of the support bar is not a permanent installation. It can be removed allowing national flags to be properly folded when not in use.

In regards to developing and marketing the support bar it can be retailed as a separate unit or sold as a component of a kit containing the necessary display items i.e. swivel hooks and draw ropes.

1. Utilization of support bar invention on flags maintains a fixed vertical extension of its width. This minimizes the need for continuous taut rope tension presently required for a functional and complete display of pole mounted flags.

2. Installed support bar provides added resistance to furling on pole mounted banners having lettering and numbers depicting a message. This results in a more comprehensive view of the entire face of the banner and its basic theme.
